(19) United States
(12) Patent Application Publication
(10) Pub. No.: US 2009/0093245 A1
(43) Pub. Date: Apr. 9, 2009

(54) Method of protecting multimedia unit against abnormal conditions and protection system therefor

(75) Inventors: Hsin-Heng Su, Changhua County (TW); Ming-Yi Tsai, Taichung (TW); Shiun-Chih Liao, Taichung (TW)

Correspondence Address: BACON & THOMAS, PLLC, 625 SLATERS LANE, FOURTH FLOOR, ALEXANDRIA, VA, 22314-1176, US

(73) Assignee: CHUNGHWA UNITED TELEVISION CO., LTD., Taichung (TW)

(21) Appl. No.: 11/905,774

(22) Filed: Oct. 4, 2007

(51) Int. Cl. H04M 3/00

(52) U.S. Cl. 455/420

(57) ABSTRACT

A protection system includes a multimedia unit, which is able to output a warning signal under an abnormal condition thereof and to restart on receipt of a restart signal, in which a phone number message for identifying a source of the restart signal is included; Ethernet for transmitting the warning signal output by the multimedia unit; a phoneline network for transmitting the restart signal to the multimedia unit; a supervising unit for receiving the warning signal sent via Ethernet and then outputting the restart signal via the phoneline network; and a filter unit located between the multimedia unit and the phoneline network for receiving the restart signal via the phoneline network, and being internally provided with a list of phones containing the phone number message included in the restart signal for determining whether to transmit the restart signal to the multimedia unit according to the source of the restart signal.

### FIELD OF THE INVENTION

The present invention relates to a protection system and method for protecting multimedia against abnormal conditions, and more particularly to a protection system and method that allows a multimedia unit under an abnormal condition to output a warning signal and uses a filter unit to filter a restart signal, so that the multimedia unit receiving the restart signal could remove the abnormal condition and be restarted.

### BACKGROUND OF THE INVENTION

About the term “information appliances”, it refers to, on the one hand, some of the traditional electric home appliances, including TV set, refrigerator, and some small-sized household appliances, such as electric oven, microwave oven, percolator, etc., that have been added with new software or hardware technique to increase new applications thereof; and on the other hand, to some information products that have been improved and could be used as convenient as general household appliances. An information appliance may be associated with a computer and network to have the ability of linking to a network or being controlled via a network, so as to provide users with largely widened services. Communication media that may be adopted by information appliances include Internet, cables for cabled TV set, digital subscriber line (DSL), satellite, and microwave.

Among different information appliances, the Set Top Box is one of the best developed items. Taiwan Patent No. M306745 discloses a Set Top Box with audio/video (AV) switching interface comprising a signal receiving and transmitting unit for receiving and converting a digital AV signal into a transport stream (TS) signal and then sending out the latter; a central processing unit (CPU) connected to the signal receiving and transmitting unit for converting the TS signal into various AV signals; a data memory connected to the CPU to serve as a register for reading out or writing in data; an input unit connected to the CPU for receiving AV signals from other AV apparatus; an output unit connected to the CPU for further processing decoded AV signals to form various AV output signals; an AV switching unit connected to the CPU, the input unit, and the output unit so as to switch the VA output signals from the input unit and the output unit; and a control unit connected to the CPU and including a key pad, a remotely controlled receiver, and a remote controller. The key pad is connected to the CPU and has specific control functions. The remotely controlled receiver is connected to the CPU for receiving signals from the remote controller and sending the received signals to the CPU.

In the event the Set Top Box is in an abnormal condition, such as shut down due to overheat, a user unfamiliar with the structure of the Set Top Box would usually call a related dealer for on-site service, which inevitably requires a lot of labor, traffic, and time costs. According to statistic data from related dealers, as a matter of fact, most frequently abnormal conditions of the Set Top Box could be easily solved simply by restarting the Set top Box without the necessity of wasting a lot of money.

It is therefore a common target of related dealers to solve the above problem by developing a protection system and method for protecting a multimedia unit against abnormal conditions.

### SUMMARY OF THE INVENTION

A primary object of the present invention is to provide a protection system that allows a multimedia unit under an abnormal condition to output a warning signal and uses a filter unit to filter a restart signal, so that the multimedia unit receiving the filtered restart signal could remove the abnormal condition and be restarted.

To achieve the above and other objects, the protection system according to the present invention includes a multimedia unit, which is able to output a warning signal under an abnormal condition thereof and to restart on receipt of a restart signal, in which a phone number message for identifying a source of the restart signal is included; Ethernet for transmitting the warning signal output by the multimedia unit; a phoneline network for transmitting the restart signal to the multimedia unit; a supervising unit for receiving the warning signal sent via Ethernet and then outputting the restart signal via the phoneline network; and a filter unit located between a signal input end of the multimedia unit and the phoneline network for receiving the restart signal via the phoneline network, and being internally provided with a list of phones containing the phone number message included in the restart signal for determining whether to transmit the restart signal to the multimedia unit according to the source of the restart signal.

Another object of the present invention is to provide a protection method including a warning step, in which a multimedia unit outputs via Ethernet a warning signal when the multimedia unit is in an abnormal condition; a supervising step, in which a supervising unit receives the warning signal output in the warning step and outputs a restart signal via a phoneline network, wherein the restart signal includes a phone number message for identifying a source of the restart signal; and a filtering step, in which a filter unit receives and analyzes the restart signal and determines whether the source of the received restart signal satisfies a list of phones provided in the filter unit, so as to determine whether to transmit the restart signal to the multimedia unit or not, wherein the list of phones contains the phone number message included in the restart signal; and a restarting step, in which the multimedia unit receives the restart signal sent out in the supervising step, and is powered off and then restarted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a framework of a protection system for protecting multimedia unit against abnormal conditions according to a preferred embodiment of the present invention; and

FIG. 2 is a flowchart showing the steps included in a protection method of protecting multimedia unit against abnormal conditions according to a preferred embodiment of the present invention.

### DETAILED DESCRIPTION OF THE PREFERRED EMBODIMENTS

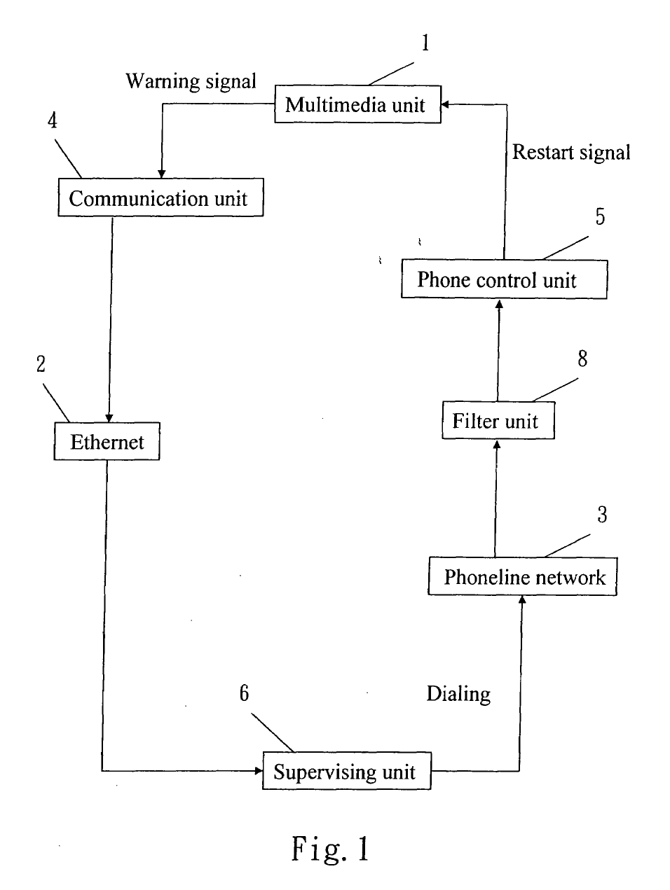

Please refer to FIG. 1, which schematically shows a framework of a protection system for protecting multimedia unit against abnormal conditions according to a preferred embodiment of the present invention. As shown, the protection system of the present invention includes a multimedia unit 1, which is able to output a warning signal under an abnormal condition thereof and to restart on receipt of a restart signal; Ethernet 2 for transmitting the warning signal output by the multimedia unit 1; a phoneline network 3 for transmitting the restart signal to the multimedia unit 1; a communication unit 4, such as a router or a modem, provided between the multimedia unit 1 and Ethernet 2 as an interface between them; a phone control unit 5 provided between the multimedia unit 1 and the phoneline network 3 for controlling power supplied to the multimedia unit 1; a supervising unit 6 for receiving the warning signal sent via Ethernet 2 and then outputting the restart signal via the phoneline network 3; and a filter unit 8 located between a signal input end of the multimedia unit 1 and the phoneline network 3 for receiving the restart signal via the phoneline network 3, and analyzing the source of the received restart signal to filter the restart signal to be transmitted to the multimedia unit 1.

In the preferred embodiment of the present invention, the multimedia unit 1 may include a digital Set Top Box (not shown); the restart signal includes a phone number message for identifying the source of the restart signal; and the filter unit 8 is internally provided with a list of phones containing the phone number message in the restart signal, so as to determine whether to transmit the restart signal to the multimedia unit 1 or not according to the source of the restart signal.

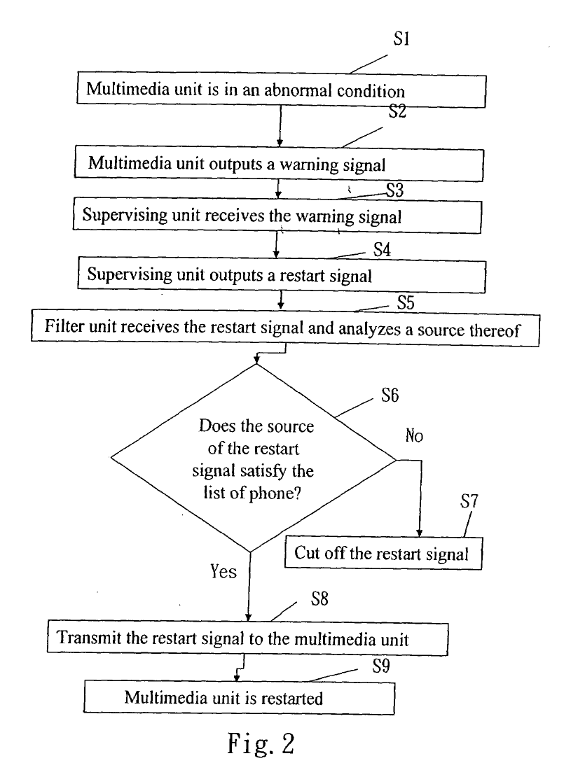

The present invention also provides a protection method of protecting multimedia unit against abnormal conditions, and FIG. 2 is a flowchart showing the steps included in the protection method according to a preferred embodiment of the present invention. The protection method of the present invention is applicable to the above-mentioned multimedia unit 1, and includes a warning step, a supervising step, a filtering step, and a restarting step.

In the warning step, when the multimedia unit 1 is in an abnormal condition (S1), a warning signal is output by the multimedia unit 1 via Ethernet 2 (S2).

In the supervising step, a supervising unit 6 receives the warning signal output in the warning step (S3), and outputs a restart signal via a phoneline network 3 (S4), wherein the restart signal includes a phone number message for identifying the source of the restart signal.

In the filtering step, a filter unit 8 receives and analyzes the restart signal (S5) and determines whether the source of the received restart signal satisfies a list of phones provided in the filter unit 8 (S6), so as to determine whether to transmit the restart signal to the multimedia unit 1 or not (S7, S8). Wherein, the list of phones contains the phone number message included in the restart signal.

In the restarting step, the multimedia unit 1 receives the restart signal sent out in the supervising step, and is powered off and then restarted (S9).

The supervising step may further include a recording step (not shown), in which the source of the warning signal and the time receiving the warning signal are recorded.

The present invention provides the following advantages:
1. When the multimedia unit 1 is in an abnormal condition and outputs the warning signal, the supervising unit 6 automatically outputs the restart signal, which is filtered at the filter unit 8 and then transmitted to the multimedia unit 1 for the latter to restart automatically. Therefore, the traffic, labor, and time costs required for on-site service can be saved.
2. The use of Ethernet 2 and the phoneline network 3 to receive the warning signal and transmit the restart signal, respectively, enables the restart signal to be transmitted via the less busy phoneline network 3 when the traffic over Ethernet 2 is heavy. Therefore, the timely transmission of the restart signal is ensured, and the phoneline network 3 may be better utilized in signal transmission.
3. With the list of phones provided in the filter unit 8, a restart signal with a phone number message not included in the list of phones is filtered out by the filter unit 8 without causing any mistake in the automatic restart of the multimedia unit 1.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A protection system for protecting multimedia unit against abnormal conditions, comprising:
a multimedia unit, which is able to output a warning signal under an abnormal condition thereof and to restart on receipt of a restart signal, in which a phone number message for identifying a source of the restart signal is included;
Ethernet for transmitting the warning signal output by the multimedia unit;
a phoneline network for transmitting the restart signal to the multimedia unit;
a supervising unit for receiving the warning signal sent via Ethernet and then outputting the restart signal via the phoneline network; and
a filter unit located between a signal input end of the multimedia unit and the phoneline network for receiving the restart signal via the phoneline network, and analyzing a source of the received restart signal to filter the restart signal to be transmitted to the multimedia unit; the filter unit being internally provided with a list of phones containing the phone number message included in the restart signal, so as to determine whether to transmit the restart signal to the multimedia unit or not according to the source of the restart signal.

2. The protection system for protecting multimedia unit against abnormal conditions as claimed in claim 1, wherein the multimedia unit includes a digital Set Top Box.

3. The protection system for protecting multimedia unit against abnormal conditions as claimed in claim 1, further comprising a communication unit provided between the multimedia unit and Ethernet.

4. The protection system for protecting multimedia unit against abnormal conditions as claimed in claim 3, wherein the communication unit is a router.

5. The protection system for protecting multimedia unit against abnormal conditions as claimed in claim 3, wherein the communication unit is a modem.

6. The protection system for protecting multimedia unit against abnormal conditions as claimed in claim 1, further comprising a phone control unit provided between the multimedia unit and the phoneline network for controlling power supplied to the multimedia unit.

7. A method of protecting multimedia unit against abnormal conditions, comprising:
a warning step, in which a multimedia unit outputs via Ethernet a warning signal when the multimedia unit is in an abnormal condition;
a supervising step, in which a supervising unit receives the warning signal output in the warning step and outputs a restart signal via a phoneline network; wherein the restart signal includes a phone number message for identifying a source of the restart signal; and
a filtering step, in which a filter unit receives and analyzes the restart signal and determines whether the source of the received restart signal satisfies a list of phones provided in the filter unit, so as to determine whether to transmit the restart signal to the multimedia unit or not; wherein the list of phones contains the phone number message included in the restart signal; and
a restarting step, in which the multimedia unit receives the restart signal sent out in the supervising step, and is powered off and then restarted.

8. The method of protecting multimedia unit against abnormal conditions as claimed in claim 7, wherein the supervising step further includes a recording step, in which a source of the warning signal and a time receiving the warning signal are recorded.
